(19) United States
(12) Patent Application Publication
(10) Pub. No.: US 2007/0039235 A1
(43) Pub. Date: Feb. 22, 2007

(54) Hardenable termite-controlling composition

(76) Inventors: Shinji Yoshida, Osaka-shi (JP); Toyoharu Obata, Osaka-shi (JP); Shigeto Yamada, Tokushima-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/574,109

(22) PCT Filed: Sep. 29, 2004
(86) PCT No.: PCT/JP04/14217

§ 371 Date: Mar. 31, 2006

(30) Foreign Application Priority Data
Oct. 1, 2003 (JP) 342219/2003
Apr. 28, 2004 (JP) 134479/2004

(51) Int. Cl. A01M 1/24

(52) U.S. Cl. 43/124

(57) ABSTRACT

A termite-controlling layer is formed with a particulate hardenable termite-controlling composition which comprises a hydraulic material, a soil and/or a termiticide, on an area to be treated. The soil may comprise a gravel component and a fine grain component, and the weight ratio of the gravel component relative to the fine grain component may be about 99.9/0.1 to 5/95. The fine grain component may comprise a sand component and a dirt component, and the weight ratio of the sand component relative to the dirt component may be about 99/1 to 10/90. The hardenable termite-controlling composition may further comprise a biocidal component, a deodorant component, or a humidity-conditioning component. In a termite-controlling process, the termite-controlling layer may be formed by laying the hardenable termite-controlling composition on the area to be treated, and applying at least a water to the laid hardenable termite-controlling composition. The use of the composition can effectively control termites in an underfloor area of a wooden building or a park.

### TECHNICAL FIELD

The present invention relates to a hardenable (or hardening) termite-controlling composition which can effectively control termite damages in wooden (wood-based) buildings and the like, and a termite-controlling process using the composition.

### BACKGROUND ART

Termites cause damages and destruct wooden objects such as wooden buildings, subterranean cables and the like. As a method for controlling such termite damages to wooden buildings, Japanese Patent Application Laid-Open No. 230451/1985 (JP-A-60-230451) (Patent document 1) discloses a process for restraining underfloor humidity, by treating an underfloor ground of a building with a termiticide, followed by allowing a self-flowing water-hardening composition comprising a hydraulic cement, a water-reducing admixture, a water retention agent, an aggregate, and a water to self-spread on the underfloor ground. This literature describes that lowering the underfloor humidity contributes to the decrease of termite occurrence, and that highly flowing composition increases working efficiency.

However, the self-flowing hydraulic composition comprising water does lack in transportability. Further, since the composition easily hardens, the composition is short of the handleability. Moreover, even if the termiticide is applied to the underfloor ground, the termiticide will flow out or diffuse over time, as a result, the termiticide is inferior in sustainability.

Additionally, Japanese Patent Application Laid-Open No. 154564/1996 (JP-A-8-154564) (Patent document 2) discloses a method for preventing a wood construction from termite damage, which comprises directly applying a cement mortar or a concrete to an underfloor ground, placing zinc-coated steel sheets (or galvanized sheet irons) on the cement mortar or the concrete, and galvanizing the joints and perimeters of the zinc-coated steel sheets with a hot-dip zincing (a zinc spray deposit).

However, this method needs not only placing zinc-coated steel sheets on the cement mortar or the concrete, but also galvanizing joints and perimeters of the zinc-coated steel sheets with a hot-dip zincing. Therefore, the method is deteriorated in working efficiency, and cannot conveniently and effectively inhibit (or prevent) the termite damages. Further, since the zinc-coated steel sheets are necessary, an applicable area of this method is restricted, and this method cannot apply to an area where the appearance may be impaired through the method.

Patent document 1: Japanese Patent Application Laid-Open No. 230451/1985 (JP-A-60-230451)

Patent document 2: Japanese Patent Application Laid-Open No. 154564/1996 (JP-A-8-154564)

### DISCLOSURE OF THE INVENTION

### Problems to be Solved by the Invention

Therefore, an object of the present invention is to provide a hardenable (settable or curable) termite-controlling composition which can effectively control (inhibit or suppress) termites, further, which is not only excellent in transportability and handleability, but also can greatly improve in working efficiency; and a termite-controlling process using the same.

Another object of the present invention is to provide a hardenable termite-controlling composition which forms a uniform termite-controlling layer in combination with a hydraulic (or water-hardening, or water-setting) material to ensure effective control of termites; and a termite-controlling process using the same.

Still another object of the present invention is to provide a hardenable termite-controlling composition, even in the case of comprising a dirt component (e.g., a clay and a silt), the composition can form a termite-controlling layer and can maintain an appearance in a park or a cemetery (or a graveyard); and a termite-controlling process using the same.

### MEANS TO SOLVE THE PROBLEMS

The inventors of the present invention made intensive studies to achieve the above objects and finally found that a specific-hardenable composition comprising a hydraulic material, a soil and/or a termiticide is not only excellent in transportability and handleability, but also can easily form a termite-controlling layer, and that such a composition can control the termites effectively and efficiently. The present invention was accomplished based on the above findings.

That is, the hardenable termite-controlling composition (hereinafter, also simply referred to as “a controlling composition (control composition)”, “a hardenable composition”, “a composition” or the like) of the present invention is in the form of a dust-granule mixture (or in the form of a particle), and comprises a hydraulic material, a soil and/or a termiticide. Specifically, the present hardenable termite-controlling composition is any one of the following compositions (i) to (iii):

(i) a hardenable termite-controlling composition comprising a hydraulic material and a soil, and is in the form of a dust-granule mixture;

(ii) a hardenable termite-controlling composition comprising a hydraulic material and a termiticide, and is in the form of a dust-granule mixture; and

(iii) a hardenable termite-controlling composition comprising a hydraulic material, a soil and a termiticide, and is in the form of a dust-granule mixture.

The above hardenable termite-controlling composition is usually prepared without mixing a water (free from a water as an admixture). The soil may comprise a gravel component and a fine grain component, and the proportion (weight ratio) of the gravel component relative to the fine grain component [the former/the latter] may be about 99.9/0.1 to 5/95. Moreover, the fine grain component may comprise a sand component and a dirt component, and the proportion (weight ratio) of the sand component relative to the dirt component [the former/the latter] may be about 99/1 to 10/90. The soil may contain a crushed (or fractured, pulverized) inorganic waste (or scrap, damaged material). Moreover, the proportion (weight ratio) of the soil relative to the hydraulic material [the former/the latter] may be about 95/5 to 70/30.

In an embodiment of the present invention, a process for controlling a termite may comprise at least step (A) for laying the hardenable termite-controlling composition on an area (or field) to be treated. Moreover, the termite-controlling process may comprise a step (A) for laying a hardenable termite-controlling composition on an area to be treated, and a step (B) for applying at least a water to the laid hardenable termite-controlling composition. The step (B) may comprise a step (B₁) for applying a liquid containing at least a water to the laid hardenable termite-controlling composition, or a step (B₂) for applying a concrete or a soil containing at least water over the laid hardenable termite-controlling composition. Incidentally, the liquid (an aqueous liquid) in the step (B₁) or the concrete or the soil in the step (B₂) may contain a termiticide.

Moreover, in another embodiment of the present invention, a termite-controlling process comprises a step (C) for mixing the hardenable termite-controlling composition and at least a water, and a step (D) for laying the mixture on an area to be treated. Incidentally, in the step (C), the hardenable termite-controlling composition, the water and a termiticide may be mixed.

The area (or colony) to be treated in the present termite-controlling process may include, for example, an invasion area, an inhabited (inhabitable) area, or a breeding (generating) area of termites.

### EFFECTS OF THE INVENTION

According to the present invention, since a hardenable termite-controlling composition is in the form of a dust-granule mixture, the composition is not only excellent in transportability and handleability, but also can greatly improve working efficiency. Moreover, the composition can form a tight (or rigid) termite-controlling layer in combination with a hydraulic material, and realizes the effective termite control (suppression). Further, according to the present invention, even if the composition comprises a dirt component (e.g., a clay and a silt), the composition can form the termite-controlling layer, and the formed layer does not deteriorate the outdoor scenery, such as a park, a cemetery (or a grave- or churchyard) and the like. Moreover, use of a crushed inorganic waste as a soil achieves an effective utilization of resources. Further, the composition containing a deodorant component can reduce the underfloor mustiness (or musty odor). In addition, the composition containing a humidity-conditioning component can improve a termite-controlling activity regardless of the humidity of the atmosphere.

### DETAILED DESCRIPTION OF THE INVENTION

[Hardenable Termite-Controlling Composition]

The hardenable termite-controlling composition is in the form of a dust-granule mixture, comprises a hydraulic material, a soil and/or a termiticide, and is usually prepared without mixing water (free from a water as an admixture). The hardenable termite-controlling composition may comprise a hydraulic material and at least one component of a soil and a termiticide, or may comprise a hydraulic material, a soil and a termiticide.

(Hydraulic Material)

The hydraulic material (or hydraulic substance) is not particularly limited to a specific one, as far as the hydraulic material constitutes a particulate hardenable composition in combination with a soil and/or a termiticide. The hydraulic material may include, for example, an air-setting (or air-hardening, or unhydraulic) cement [for example, an air-setting single (non-blended) cement (e.g., plasters (or gypsums) such as a casting plaster (or calcined gypsum, burnt gypsum, hemihydrate gypsum) and an anhydrous gypsum plaster; limes such as a calcium hydroxide (or hydrated lime, slaked lime) and a dolomite plaster) and an air-setting blended cement (e.g., a magnesia cement (magnesium oxychloride cement))], and a hydraulic cement [for example, a hydraulic single (non-blended) cement (e.g., portland cements such as a portland cement and a high-early-strength portland cement; high alumina cements such as an alumina cement and a lime alumina cement) and a hydraulic blended cement (e.g., lime-blended cements such as a lime slag cement and a lime volcanic ash cement; mixed portland cements such as a portland blastfurnace slag cement, a silica cement, a portland pozzolan cement and a portland flyash cement; and high sulfate slag cements (or supresulphated slag cements, sulfated slag cements))]. These hydraulic materials may be used alone or in combination.

Preferred hydraulic material may include, for example, portland cements such as a portland cement; and blended portland cements such as a portland blast-furnace slag cement, a silica cement, a pozzolanic cement and a fly ash cement.

(Soil)

In the case where the hardenable termite-controlling composition of the present invention comprises a soil, the soil is not particularly limited to a specific one, as long as the soil constitutes a particulate termite-controlling composition. For example, the soil may contain at least a gravel component.

The gravel component may be a gravel or rock particle which is not less than 2 mm in diameter, and the particle size of the gravel component may be, for example, about 2 to 8 mm (about 9 mesh to 2 and ½ mesh), preferably about 2 to 5 mm (about 9 mesh to 3 and ½ mesh), and more preferably about 2 to 3.5 mm (about 9 mesh to 6 mesh) (the mesh unit is based on the Tyler notation). The presence of the gravel component in the soil can effectively prevent the controlling layer from invading or tunneling of termites.

Moreover, the soil in the present invention may comprise a gravel component and a fine grain component. The fine grain component may comprise at least a sand component, and the sand component comprises at least one member selected from a coarse sand (about 0.2 to 2 mm in particle size) and a fine sand (about 0.02 to 0.2 mm in particle size). Also, the fine grain component may further comprise a dirt component. The dirt component comprises at least one member selected from a clay (which has a particle size of, for example, not more than 0.002 mm, and preferably about 0.00001 to 0.002 mm) and a silt (which has a particle size of, for example, about 0.002 to 0.02 mm). When the fine grain component (particularly the dirt component) is included in the soil, the hardenable termite-controlling composition has an appearance of the natural soil. Therefore, even if the composition is used in outdoor places such as a park and a cemetery (or a grave- or churchyard), the composition will not spoil or impair the surrounding appearance.

The proportion (weight ratio) of the gravel component relative to the fine grain component [the former/the latter] may be, for example, about 99.9/0.1 to 5/95 (for example, about 99/1 to 25/75), preferably about 99/1 to 50/50, and more preferably about 95/5 to 75/25.

The proportion (weight ratio) of the sand component relative to the dirt component is not particularly limited to a specific one, as long as a particulate hardenable termite-controlling composition can be formed, for example, may be utilized even the soil containing the sand component and the dirt component in the weight ratio of [the former/the latter]=about 99/1 to 10/90, preferably about 95/5 to 50/50, and more preferably about 90/10 to 60/40. In the present invention, since a natural (or un-processed) soil containing a large amount of the dirt component is applicable or usable, a washing operation conventionally required for forming an aggregate (or removing dirt components) from the soil is not necessary. Thus, the present invention can inexpensively and easily provide a hardenable termite-controlling composition. Further, the present invention does not cause an environmental pollution and the like induced by (associated with) the washing operation.

The soil in the present invention can, for example, be classified into the following classes, based on the proportions of the clay, silt and sand components: sandy soils (corresponding to “sand” in ISSS soil texture classification) (e.g., a loamy sand and a sand soil); loam soils (e.g., a loam, a sandy loam and a silt loam); clay loam soils (e.g., a clay loam, a sandy clay loam and a silt clay loam); and clay (daxey soils) (e.g., a light clay, a sandy clay, a silt clay and a heavy clay). Incidentally, these classes of the soil comply with the soil texture classification of International Society of Soil Science (ISSS). The soil may be used alone or in combination.

Specifically, the soil may include, for example, sands such as a quartz sand (or silica sand), a river sand, a sea sand, a beach sand and a pit sand; earths [e.g., a Masado (a granite soil (or weathered granite soil) which is obtained by weathering (decomposing) of a granite); volcanic soils or volcanic ash soils such as a red earth (or a red soil, a red clay, a tuff loam), a black earth (or a black soil, a black terracotta) or a Shirasu (volcanic sandy soil); and sedimentary soils such as a river sedimentary soil], as well as a variety of gardening soils (or bonsai soils) (e.g., Akadama-soil, Kanuma-soil, Arakida-soil, a leaf soil (or leaf mould), and a Kiryuu-sand), an igneous rock (or eruptive rock) (e.g., an andesite, a granite and a rhyolite), metamorphic rocks (e.g., a quartzite and a crystalline limestone (or a marble)), and sedimentary rocks (e.g., a clay rock and a sandstone). Incidentally, the sands are generally classified into the sand soils, the granite soil is generally classified into the loamy sands or the loam soils, and the volcanic ash soil is generally classified into the clay loam soils or the clayish soils. Among these soils, in view of handleability and the cost, sandy soils such as a loamy sand (e.g., a Masado); and loam soils such as a loam, a sandy loam and a silt loam (e.g., a Masado) are preferably used.

The soil of the present invention may comprise a crushed (or fractured, pulverized) inorganic waste (or scrap, damaged material), or may comprise a combination of the crushed inorganic waste and the gravel component or the fine grain component. The crushed inorganic waste may include a waste from an artificial product and a waste from a natural product. The artificial product may include, for example, an artificial building or construction (e.g., a brick, a roof tile, a concrete building material, a mortar building material, a concrete block, a concrete pavement, an asphalt pavement and a window glass), a commodity (e.g., a plant pot, a cup and a ceramic) and the like. The natural product may include, for example, a shell (e.g., a shell of a short-neck clam, a corbicula (or a freshwater clam), a clam or a scallop), a bone (e.g., a bone of a cow, a pig or a chicken) and the like. The use of these wastes as the soil realizes the effective utilization of resources. These wastes may be crushed to a desired particle size, and for example, may be crushed to a similar particle size to the gravel, sand or dirt component, depending on the respective purposes. In view of convenience and so on, the particle size of the crushed wastes may be usually selected from the range of not more than 10 mm, for example, and is not more than 8 mm (e.g., about 0.01 to 8 mm), preferably not more than 5 mm (e.g., about 0.05 to 5 mm), and more preferably not more than 3 mm (e.g., about 0.1 to 3 mm). These crushed wastes may be used alone or in combination.

In the hardenable termite-controlling composition, the proportion (weight ratio) of the soil relative to the hydraulic material may be selected suitably, as long as the proportion is not detrimental to the hardenability of the termite-controlling composition, and the like. For example, the proportion (the former/the latter) is about 95/5 to 70/30, and preferably about 95/5 to 85/15.

In the present invention, in order to form a uniform termite-controlling layer, it is preferable to prepare a termite-controlling composition which comprises the soil and the hydraulic material uniformly mixed (or blended) together by known or conventional methods.

(Termiticide)

The hardenable termite-controlling composition of the present invention may contain a termiticide. The termite-controlling composition containing the termiticide can form a termite-controlling layer capable of not only effectively inhibiting invasion of termites but also having a termiticidal activity. The termiticide may include, for example, a synthetic compound [e.g., an organophosphorus compound such as phoxim, chlorpyrifos, fenitrothion, pyridaphenthion or isofenphos; a carbamate-series compound such as bassa (or fenobucarb) or propoxur; a pyrethroid-series compound such as cyfluthrin, permethrin, tralomethrin, fenvalerate, ethofenprox, bifenthrin, cyphenothrin, silafluofen, pyrethrin or pralethrin; a neonicotinoid-series compound such as nitenpyram, acetamiprid, (E)-1-(2-chlorothiazol-5-ylmethyl)-3-methyl-2-nitroguanidine (common name: chlothianidin), N-acetyl-N-(2-chlorothiazol-5-yl) methyl-N′-methyl-N″-nitroguanidine, N-(2-chlorothiazol-5-yl)methyl-N-methoxycarbonyl-N′-methyl-N″-nitroguanidine, 1-(6-chloro-3-pyridylmethyl)-N-nitroimidazolin-2-ylideneamine (common name: imidachloprid) or 3-(2-chloro-thiazol-5-ylmethyl)-5-[1,3,5]oxadiazinan-4-ylindene-N-nitroamine (common name: thiamethoxam); a phenylpirazole-series compound such as fipronil; a pyrrole-series compound such as chlorfenapyr; a nereistoxin-series compound such as bensultap; an amidinohydrazone-series compound such as hydramethylnone; a semicarbazone-series compound such as α-(α, α, α-trifluoro-m-toluoyl)-p-tolunitrile 4-(p-trifluoromethoxyphenyl)semicarbazone; a higher alcohol compound such as tridecanol or hexadecanol (e.g., a C₁₀₋₂₀alkylalcohol compound); a boric acid such as orthoboric acid; a chitin synthesis inhibitor such as lufenuron, hexaflumuron, diflubenzuron or flufenoxuron; a juvenile hormone-mimic compound such as methoprene or hydroprene; and the like], a natural compound [e.g., Hiba oil, Hiba neutral oil, a fatty acid such as decanoic acid or octanoic acid; a plant belonging to a genus Moringa or a genus Marah, or an extract thereof (e.g., Japanese Patent Application Laid-Open Nos. 41011/1991 (JP-A-3-41011), 329514/1994 (JP-A-6-329514), 158008/2001 (JP-A-2001-158008), 158009/2001 (JP-A-2001-158009), 172115/2001 (JP-A-2001-172115), 63220/2000 (JP-A-2000-63220) and 170908/2001 (JP-A-2001-170908)); and the like]. These termiticides may be used alone or in combination. In view of the inhibitory activity against termites, among these termiticides, the neonicotinoid-series compound is preferred, and chlothianidin is particularly preferred.

Additionally, these termiticides may be used in any formulation, for example, a liquid formulation such as a soluble concentrate, a wettable powder (or a water-dispersible powder), a suspension concentrate, a dispersible concentrate, an emulsifiable concentrate, an oil solution, and a lotion; and a solid formulation such as a dust (or a dustable powder, a dust formulation), a granule (granular), a microcapsule, a microsphere, a flowable, and a foam. Moreover, in order to use the termiticide in combination with the hydraulic material, the termiticide may have an excellent (high) alkali resistance, for example, may be in the form of a microcapsule. Incidentally, the microcapsule may be used in a solid formulation or in a liquid formulation such as a dispersible concentrate or suspension concentrate having microcapsules dispersed in a solvent.

The proportion of the termiticide is not particularly limited to a specific one, and for example, may be about 0.01 to 1000 parts by weight, preferably about 0.05 to 300 parts by weight, and more preferably about 0.1 to 200 parts by weight, relative to 100 parts by weight of the hydraulic material. Moreover, in the case where the hardenable termite-controlling composition comprises the soil, the hydraulic material, and the termiticide, the amount of the termiticide may be, for example, about 0.001 to 30 parts by weight, preferably about 0.005 to 20 parts by weight, and more preferably about 0.01 to 10 parts by weight, relative to 100 parts by weight of the total amount of the soil and the hydraulic material.

(Biocidal Component)

The hardenable termite-controlling composition may further contain a preservative (or antiseptic) and/or an antifungal (or antimold) agent (or a biocidal component, a biocide). The preservative and/or antifungal agent (or the biocidal component) may include, for example, an organic iodine-containing compound such as 3-bromo-2,3-diiodo-2-propenylethylcarbonate, 3-iodo-2-propynylbutylcarbamate, 2,3,3-triiodoallyl alcohol or parachlorophenyl-3-iodopropargyl formal; a benzimidazole-series compound and a benzothiazole-series compound such as 2-(4-thiazolyl)benzimidazole or 2-thiocyanomethylthiobenzothiazole; a triazole-series compound such as 1-(2-(2′,4′-dichlorophenyl)-1,3-dioxolan-2-ylmethyl)-1H-1,2,4-triazole, 1-(2-(2′,4′-dichlorophenyl)-4-propyl-1,3-dioxolan-2-yl methyl)-1H-1,2,4-triazole or α-(2-(4-chlorophenyl)ethyl)-α-(1,1-dimethylethyl)-1H-1, 2,4-triazole-1-ethanol; a natural compound such as 4-isopropyltropolone (a hinokitiol) or a borax; a biocidal metal [e.g., a silver-containing compound (e.g., a silver metal; a silver halide such as AgCl, AgF or AgF₂; a silver oxide such as Ag₂O and AgO; a silver sulfide such as Ag₂S; a silver salt of an oxyacid such as Ag₂SO₄, Ag₂CrO₄, Ag₃PO₄, Ag₂CO₃ or Ag₂SiO₃), a copper-containing compound, and a zinc-containing compound] and others. These preservative and/or antifungal agents (or biocidal components) may be used alone or in combination. These preservative and/or antifungal agents (or biocidal components) may be also used in any formulation including various liquid formulations or solid formulations as exemplified in the above-mentioned termiticide section.

The amount of the preservative/antifungal agent (or biocidal component) is not particularly limited to a specific one, and may be, for example, about 0.01 to 1000 parts by weight, preferably about 0.05 to 300 parts by weight, and more preferably about 0.1 to 200 parts by weight, relative to 100 parts by weight of the hydraulic material. Moreover, when the hardenable termite-controlling composition comprises the soil, the hydraulic material, and the termiticide, the amount of the preservative/antifungal agent (or biocidal component) may be about 0.001 to 30 parts by weight, preferably about 0.005 to 20 parts by weight, and more preferably about 0.01 to 10 parts by weight, relative to 100 parts by weight of the total amount of the soil and the hydraulic material.

(Deodorant Component)

The hardenable termite-controlling composition of the present invention may further contain a deodorant component, or the like. The deodorant component may include, for example, a catalyst (or a photocatalyst) or an adsorbent [e.g., a metallic compound such as a metal oxide (e.g., an oxide semiconductor such as a magnesium oxide, a titanium oxide (TiO₂), a zirconium oxide, a vanadium oxide, a tungsten oxide (e.g., WO₃), an iron oxide, a copper oxide, a silver oxide, a zinc oxide, a cadmium oxide, an indium oxide or a tin oxide), a metal sulfide (e.g., a sulfide semiconductor such as a cadmium sulfide or a zinc sulfide), a metal chalcogenide (e.g., CdSe, In₂Se₃ and WSe₃), or a metal salt of an inorganic acid (e.g., a metal phosphate such as a titanium phosphate, a zirconium phosphate or a tin phosphate); a carbon compound (e.g., an activated carbon); a silicon compound (e.g., a silica gel and a silica-alumina); and a natural mineral (e.g., a bentonite and a kaoline)].

As the deodorant component, there may be used a catalytic composition described in Japanese Patent Application Laid-Open No. 229409/1996 (JP-A-8-229409), i.e., a catalytic composition comprising a phosphate of a quadrivalent metal, a hydroxide of a bivalent metal and a photocatalyst. In the catalytic composition, the phosphate may include a phosphate of a metal of group 4 or 4B of the Periodic Table of Elements, particularly a titanium phosphate, a zirconium phosphate, a tin phosphate, and the like. A phosphoric acid constituting the phosphate may be an orthophosphoric acid, a metaphosphoric acid, a pyrophosphoric acid, a triphosphoric acid and a tetraphosphoric acid. The phosphate may be used alone or in combination.

The hydroxide of the bivalent metal is not particularly limited to a specific one, and may be a hydroxide of typical metal or transition metal such as a metal of group 1B (e.g., copper), a metal of group 2A (e.g., magnesium and calcium), a metal of group 2B (e.g., zinc and cadmium), a metal of group 7A (e.g., manganese) or a metal of group 8 (e.g., iron, ruthenium, cobalt, rhodium, nickel and palladium) of the Periodic Table of Elements. The particularly preferred bivalent metal may include copper, zinc and the like, further, iron, cobalt and nickel are also preferred. The hydroxide of the bivalent metal may be used alone or in combination. These hydroxides of the bivalent metal are usually water-insoluble or sparingly (or hardly) soluble in a range from a weakly acidic condition to a weakly alkaline condition (i.e., about pH 4 to 10). Incidentally, a composition comprising a phosphate of a quadrivalent metal and a hydroxide of a bivalent metal may be in a complex state by co-precipitation as a mixed gel and the like.

The photocatalyst includes, for example, the above described photocatalyst, a metal sulfide (or a sulfide semiconductor), a metal oxide (or an oxide semiconductor) and the like. Preferred photocatalyst may include, for example, an oxide semiconductor such as a titanium oxide. The photocatalyst may be used alone or in combination.

The proportion of the phosphate relative to the hydroxide is, in terms of the ratio (or proportion) of the metal atoms, for example, (the bivalent metal/the quadrivalent metal)=about 0.1 to 10, preferably about 0.2 to 7, and more preferably about 0.2 to 5. Moreover, the amount of the photocatalyst to be used may be about 1 to 1000 parts by weight, preferably about 10 to 750 parts by weight, and more preferably about 20 to 500 parts by weight, relative to 100 parts by weight of the total amount of the phosphate and the hydroxide.

Incidentally, in the present invention, the catalytic composition may further contain an biocidal metal component (particularly, the silver compound and the like). The combination of the phosphate of the quadrivalent metal, the hydroxide of the bivalent metal, the photocatalyst and the above exemplified biocidal metal component (particularly, the biocidal metal component such as the silver compound) efficiently realizes a deodorant property as well as a biocidal activity. The proportion of the biocidal metal component relative to the total amount of the catalytic composition and the biocidal metal components, in terms of metal (e.g., a silver metal) may be about 0.1 to 10% by weight, preferably about 0.5 to 8% by weight, and more preferably about 0.5 to 7% by weight.

Such a catalytic composition is excellent in deodorant property, and can be used suitably. Incidentally, such a catalytic composition is available from Japan EnviroChemicals, Ltd., as “Seventol N-PC”, “Seventol N-FP” and the like.

Incidentally, when the catalytic composition has a deodorant property and/or a biocidal activity, the catalytic composition can act as a deodorant component and/or a biocidal component. In particular, the catalytic composition which has a deodorant property and/or a biocidal activity can improve the handleability (or applicability) of the hardenable termite-controlling composition. Moreover, since a carbon compound such as an activated carbon (or an activated charcoal), a silicon compound, a natural mineral and the like usually have a deodorant property as well as a humidity-conditioning property, such a compound can act as a deodorant component and/or a humidity conditioning component. As a result, the composition can improve the handleability, and the termite-controlling property regardless of the humidity (or damp, wetness) of the environment (surroundings).

The deodorant component may be used alone or in combination. Among these deodorant components, from the viewpoint of capacity to impart a plurality of characteristics, the catalytic composition (particularly, a biocidal metal-containing catalytic composition), a carbon compound (particularly, an activated carbon) and the like are preferred. The proportion of these deodorant components is not particularly limited to a specific one, and for example, may be about 0.1 to 1000 parts by weight, preferably about 0.5 to 300 parts by weight, and more preferably about 1 to 200 parts by weight, relative to 100 parts by weight of the hydraulic material.

(Humidity-Conditioning Component)

The hardenable termite-controlling composition of the present invention may further contain a humidity-conditioning component (humidity-controlling component). The humidity-conditioning component may include, for example, humidity-conditioning components (or humidity-conditioning agents) such as a clay mineral [e.g., a zeolite, a sepiolite, an attapulgite (a palygorskite) and the like], a synthetic zeolite, a coal (e.g., a charcoal and a bamboo charcoal) and the like. The humidity-conditioning component may be used alone or in combination.

The proportion of the humidity-conditioning component is not particularly limited to a specific one, and for example, may be about 0.1 to 1000 parts by weight, preferably about 10 to 700 parts by weight, and more preferably about 20 to 600 parts by weight, relative to 100 parts by weight of the hydraulic material.

A variety of additives may be added to the hardenable termite-controlling composition. The additive may include a water-reducing admixture such as sodium naphthalenesulfonate; an accelerating admixture such as calcium chloride; a retarder (or a retarding admixture) such as an organic acid salt or an inorganic acid salt; a foaming agent; a plasticizer; a colorant such as a dye or a pigment; and a reinforcer. If necessary, an aggregate (e.g., a fine aggregate and a coarse aggregate) may be further added to the hardenable termite-controlling composition.

When the termitidide, the biocidal component, the deodorant component, the various additives and the like are used in the form of a liquid (or a liquid formulation), these components may be used as a mixture (or dry mixture) of the liquid formulation and the solid carrier, for example, by pre-mixing the liquid formulation and a suitable solid diluent (or a solid carrier) to give a pre-mixture, and drying the pre-mixture to obtain a solid (or dry) mixture. Moreover, if the hardenable termite-controlling composition contains a soil, the composition may be used as a mixture (or dry mixture) of a liquid formulation and the soil, which is prepared by pre-mixing the liquid formulation and the soil to give a pre-mixture, and drying the pre-mixture to obtain a solid (or dry) mixture. The hardenable termite-controlling composition of the present invention may be prepared by adequately mixing these mixtures with the hydraulic material, and if necessary the soil and the solid carrier.

Incidentally, the solid carrier is not particularly limited to a specific one, as long as the solid carrier is miscible with the liquid formulation. The solid carrier may include, for example, the humidity-conditioning component; talcs such as a talcum powder and a pagodite; clays such as a fine powder clay; pumices such as a natural rhyolitic glass and a perlite (or a pearlite); mineral particulates such as a vermiculite and a calcium carbonate; a sulfur powder; a urea powder; phytogenic particulates such as a peat moss, a wood flour (or a wood meal) and a starch; and a variety of carriers commonly used in a pesticide, a preparation for gardening and the like. These solid diluents or carriers are often used as an extender. These solid carriers may be used alone or in combination.

In the case where the termiticide, the biocidal component, the deodorant component, the various additives or the like is(are) used in the form of a solid (or a solid formulation), the hardenable termite-controlling composition may be prepared by adequately mixing the solid formulation with the hydraulic material, or may be prepared by adequately mixing the solid formulation with the soil and the hydraulic material. Incidentally, in these termite-controlling compositions, the solid carrier may be adequately utilized as an extender.

Incidentally, in order to form a uniform termite-controlling layer, it is preferred to uniformly mix the hydraulic material, the soil and/or the termiticide, and if necessary the biocidal component, the humidity-conditioning component, the deodorant component or the like in the termite-controlling composition.

[Termite-Controlling Process]

The process for controlling termite (termite-controlling process) of the present invention is not particularly limited to a specific one, as long as a termite-controlling layer can be formed by hardening the hardenable termite-controlling composition. In the termite-controlling process of the present invention, since the termite-controlling layer is hardened in one piece (or in one body), the termite-controlling layer is not destructed (or tunneled) by termites. In addition, the gravel component in the layer contributes to effective prevention of the layer from termite invading or infesting. Thus, the process of the present invention realizes effective inhibition the termite damage with preventing the termite-controlling layer from collapsing or breakdown.

The termite-controlling process of the present invention may comprise a step (A) for laying (or spreading, placing, settling, constructing, building) a hardenable termite-controlling composition on an area to be treated. The laid hardenable termite-controlling composition can be hardened with water to form a termite-controlling layer. The water may be derived from the area to be treated (e.g., a water in the soil of the area to be treated or a water (moisture vapor) in the air of the area to be treated, and preferably a water in the soil of the area to be treated), or a water may be externally applied.

For example, in the case where the area to be treated comprises a soil having a water content (a moisture content) of about 5 to 200% by weight, and preferably about 7 to 100% by weight, the hardenable termite-controlling composition is hardenable with the water from the area to form a termite-controlling layer.

In the laying step (A), the hardenable termite-controlling composition can be laid or placed by a variety of methods such as spreading, falling (flowing) and scratching (or clawing, scraping). Since the hardenable termite-controlling composition is in the form of a dust-granule mixture (or granule, fine particle), the composition is excellent in transportability and handleability, and can be easily laid. In order to avoid a void or tunnel from which the termites can invade, it is preferred that the hardenable termite-controlling composition is exhaustively (or uniformly, evenly) laid on the area to be treated in a constant thickness. The thickness of the laid hardenable termite-controlling composition (the laid thickness) may be suitably selected from the range that the composition can effectively form the termite-controlling layer. The laid thickness may be, for example, about 5 to 200 mm (e.g., about 10 to 200 mm), preferably about 15 to 100 mm (e.g., about 20 to 100 mm), more preferably about 30 to 50 mm, and usually about 10 to 50 mm (e.g., about 20 to 50 mm).

Additionally, when the termite-controlling layer contains a termiticide, the termiticide can impart an anti-termite activity to the layer. Therefore, the thickness of the laid hardenable termite-controlling composition (the laid thickness) can be thinner than that of a hardenable termite-controlling composition without a termiticide in the termite-controlling layer. In this case, the laid thickness may be, for example, about 5 to 50 mm, and preferably about 10 to 30 mm.

In particular, in the case where the laid hardenable termite-controlling composition is hardened with a water from the area to be treated, the termite-controlling layer containing the termiticide ensures to form an effective termite-controlling layer with a simple operation.

Further, in a step (B), at least a water may be applied to the laid hardenable termite-controlling composition. By applying the water to the laid composition, the hardenable termite-controlling composition is hardened to form a termite-controlling layer. Specifically, the step (B) may include, for example, a step (B₁) for applying a liquid containing at least a water (an aqueous liquid) to the laid hardenable termite-controlling composition, a step (B₂) for laying a concrete or a soil each of which containing at least a water on the laid hardenable termite-controlling composition, and so on.

In the step (B₁), a liquid containing at least a water (e.g., water) may be applied on the laid hardenable termite-controlling composition. Moreover, the aqueous liquid may be a liquid containing a termiticide (e.g., an aqueous solution or aqueous dispersion liquid containing a termiticide). Incidentally, the termiticide may include the compounds mentioned in the above section of the hardenable termite-controlling composition, and these termiticides may be used alone or in combination. The application of the termiticide achieves the effective inhibition of the termite invasion as well as the anti-termite activity of the termite-controlling layer.

The proportion of the termiticide is not particularly limited to a specific one, and may be, for example, about 0.001 to 30 parts by weight, preferably about 0.005 to 20 parts by weight, and more preferably about 0.01 to 10 parts by weight, relative to 100 parts by weight of the laid hardenable termite-controlling composition.

The aqueous liquid may further contain a biocidal component described in the section of the hardenable termite-controlling composition, and so on. The biocidal component may be, for example, in the amount of about 0.001 to 30 parts by weight, preferably about 0.005 to 20 parts by weight, and more preferably about 0.01 to 10 parts by weight, relative to 100 parts by weight of the laid hardenable termite-controlling composition.

In a method for applying the aqueous liquid (or sprinkling, spraying, watering), the aqueous liquid may be applied once or in a plurality of applications, as long as a termite-controlling layer can be formed by the method. In order to maintain the laid form of the hardenable termite-controlling composition, the liquid is preferably applied in a plurality of applications (e.g., 2 to 5 times, preferably 2 to 4 times, and more preferably 2 to 3 times). In particular, it is preferred that the amount of the first (initial) application is enough to be an amount for hardening a surface of the laid hardenable termite-controlling composition. The amount of the liquid in the first application may be any amount, as long as the hydraulic material or the termiticide in the hardenable termite-controlling composition does not flow out. The amount may be, for example, about 0.1 to 5 L/m², preferably about 0.5 to 5 L/m², and more preferably about 1 to 2 L/m². In the following application steps (e.g., in the second, third or fourth application), the liquid application may be suitably selected for hardening the laid hardenable termite-controlling composition on the whole. For example, the amount of the liquid applied in the following application steps (e.g., in the second or third application) may be about 1.5 to 30 times by weight, preferably about 3 to 20 times by weight, and more preferably about 5 to 15 times by weight, relative to the amount applied in the first application, as a total amount.

Moreover, when the liquid is applied in a plurality of times, homogenous (uniform) or heterogeneous (non-uniform) liquids may be applied in each application. For example, a water may be applied in the first application, and an aqueous solution or an aqueous dispersion liquid containing a termiticide may be applied in the following applications (e.g., in the second application). Moreover, the aqueous solution or the aqueous dispersion liquid containing a termiticide may be applied in the first application, and a water may be applied in the following application steps (e.g., in the second application). Furthermore, the aqueous solution or the aqueous dispersion liquid containing a termiticide may be applied to the laid hardenable termite-controlling composition after hardening the laid hardenable termite-controlling composition. For example, the termite-controlling layer may be formed by a plurality of applications (e.g., one and two applications) of water to harden the hardenable termite-controlling composition, and further applying the aqueous solution or the aqueous dispersion liquid containing the termiticide to the hardened termite-controlling composition.

In the step (B₂), a concrete (unhardened concrete mixture) or a soil comprising at least a water may be laid on the laid hardenable termite-controlling composition. The concrete or soil comprising a water ensures to harden the hydraulic material with the water from the concrete or soil to form the termite-controlling layer.

The concrete comprises, for example, a cement component, a water, and an aggregate (e.g., a fine aggregate and a coarse aggregate). Incidentally, the cement component constituting the concrete may include a hydraulic material described in the section of the hardenable termite-controlling composition, and so on.

The proportion of the water in the concrete may be suitably selected, depending on the water content of the area to be treated, from the range in which the strength of the concrete can be maintained and the hardenable termite-controlling composition can be hardened with the water leaching out (or percolating) from the concrete. The proportion may be, for example, about 10 to 150 parts by weight (e.g., about 30 to 100 parts by weight), and preferably about 20 to 100 parts by weight (e.g., about 40 to 100 parts by weight), relative to 100 parts by weight of the cement.

The soil may be a soil dug out from the area to be treated, or may be a soil brought from other place(s) (including a commercially available soil). The soil brought from other place may include, for example, the soils described in the section of the hardenable termite-controlling composition, and the soil may be any of the sandy soils, the loam soils, the clay loam soils or the clayish soils. Moreover, a gravel component may be found (or exist) in the soil. Among these soils, in view of the handleability and the cost, the sandy soils, the loam soils and the clay loam soils are preferred. Use of the soil realizes the termite-controlling layer which does not deteriorate or impair the surrounding appearance.

The proportion of the water in the soil is not particularly limited to a specific one, as long as the hardenable termite-controlling composition can be hardened. The proportion may be, for example, about 5 to 200 parts by weight, and preferably about 7 to 100 parts by weight, relative to 100 parts by weight of the soil.

Moreover, in the step (B₂), the concrete or the soil containing both a water and a termiticide may be laid on the laid hardenable termite-controlling composition. For example, when the concrete contains the water and the termiticide, the proportion of the termiticide may be about 0.001 to 30 parts by weight, preferably about 0.005 to 20 parts by weight, and more preferably about 0.01 to 10 parts by weight, relative to 100 parts by weight of the total amount of the cement component and the aggregate.

Moreover, in the case where the soil contains the water and the termiticide, the proportion (or amount) of the termiticide relative to 100 parts by weight of the soil may be similar to the above described amount. Incidentally, the termiticide may include the termiticides described in the section of the hardenable termite-controlling composition, and these termiticides may be used alone or in combination. The application of the termiticide can effectively inhibit the invasion of termites, as well as impart an anti-termite (termiticidal) activity to the termite-controlling layer (including a hardened concrete layer or a soil layer containing the termiticide).

The laid matter in the step (B₂) may further contain the biocidal components described in the section of the hardenable termite-controlling composition, and the like. The proportion of the biocidal component may be about 0.001 to 30 parts by weight, preferably about 0.005 to 20 parts by weight, and more preferably about 0.01 to 10 parts by weight, relative to 100 parts by weight of the total amount of the cement component and the aggregate.

Moreover, the termite-controlling process of the present invention may comprise a step (C) for mixing a hardenable termite-controlling composition with at least a water, and a step (D) for laying the mixture on an area to be treated.

In the step (C), may be mixed the hardenable termite-controlling composition and at least a water with a mixer or the like, or may be mixed the hardenable termite-controlling composition, a water, and one or not less than two termiticide(s) described above. By mixing the termiticide with the composition, it is possible to effectively inhibit the invasion of termites, as well as to impart an anti-termite activity to the termite-controlling layer.

The proportion of the water relative to the hardenable termite-controlling composition is not particularly limited to a specific one, as long as the termite-controlling layer can be formed. For example, the proportion of the water may be about 20 to 65 parts by weight, preferably about 25 to 60 parts by weight, and more preferably about 30 to 55 parts by weight, relative to 100 parts by weight of the hydraulic material.

In the step (D), the mixture can be laid on the area to be treated by known or conventional methods. In order to form a termite-controlling layer effective to control (inhibit or suppress) termites, the thickness of the laid mixture (the laid thickness) may be, for example, about 10 to 200 mm, preferably about 20 to 100 mm, and more preferably about 30 to 50 mm.

Moreover, in the case where the hardenable termite-controlling composition (itself) contains the termiticide, or in the case where the hardenable termite-controlling composition, a water and a termiticide are mixed together, since the termiticide can impart an anti-termite activity to the termite-controlling layer, the laid thickness of the mixture (or the layer containing termiticide) can be thinner than that of a mixture without termiticide (the case of the termite-controlling layer containing no termiticide). The laid thickness may be similar to the laid thickness of the hardenable termite-controlling composition in the step (A).

In the steps (A) and (D), the area (or site, location) to be treated may be anywhere the termite damage is avoidable, and often may include at least one area selected from the group consisting an infested area (or invasion area), a inhabited area (habitat area) and a bleeding area (or generating area) of termites. For example, the infested area, the inhabitable area or the bleeding area of termites may include a place (or location) where a wooden (or wood-based) building, and a subterranean (or buried) object are exist, or a surrounding place thereof. The subterranean (or buried) object may include, for example, cables such as an electric line cable and an optical fiber, pipes such as a water pipe and a gas pipe, and others. Specifically, the area to be treated may include, for example, a residential area or housing site (e.g., an underfloor ground of a building such as a wooden (wood-based) building, and a surrounding area of the building, an entrance, or a porch), a landscaping (or gardening) area (e.g., a garden or a yard), a park and a cemetery (or a grave or churchyard)) and a surrounding (or above-ground part) area of an underground or subterranean object. Incidentally, the building also includes a lumber (or timber) yard and the like, and the underfloor area may also include an area where the building comes into contact with the ground.

In particular, in the case where the hardenable termite-controlling composition comprises a dirt component, since the composition has the same texture (or appearance) as a natural soil, it does not impair the atmosphere if used in a park, a garden (or a garden park, a yard, a patio, a terrace), a cemetery (or a grave or churchyard) and the like. Therefore, even if the hardenable termite-controlling composition is used in a garden, a park or the like, the composition can protect a wooden or wood-based product used in a garden (e.g., a wood deck, a wood balcony or a wooden gardening article), a wood equipment used in a park (e.g., a wood athletic equipment, a wood slide and a wood swing), a wood bench or a wood footpath (or a footway) from the termite damage as well as in harmony with the surrounding atmosphere.

### INDUSTRIAL APPLICABILITY

The present invention is useful for controlling termites because the termite-controlling layer is formed beneath or underfloor ground of a wooden (wood-based) building and the like.

### EXAMPLES

The following examples are intended to describe this invention in further detail and should by no means be interpreted as defining the scope of the invention.

(Preparation of Hardenable Termite-Controlling Compositions)

Hardenable Termite-Controlling Composition (A-1)

Ninety (90) parts by weight of a dry granite soil (Masado) [12.6% by weight of a gravel component (2 to 5 mm in particle size), 71.8% by weight of a sand component and 15.6% by weight of a dirt component] and 10 parts by weight of a portland blast-furnace slag cement (Portland blast-furnace slag cement type-B, manufactured by Taiheiyo Cement Corporation) were mixed with a mixer to give a hardenable termite-controlling composition (A-1) containing the granite soil and the portland blast-furnace slag cement dispersed uniformly.

Hardenable Termite-Controlling Composition (B-1)

A microcapsule termiticide was prepared as described in Example 5 of Japanese Patent Application Laid-Open No. 247821/2000 (JP-A-2000-247821) containing chlothianidin as an active (effective) ingredient, hereinafter referred to as Termiticide T.

To 100 parts by weight of a dry granite soil (Masado) [12.6% by weight of a gravel component (2 to 5 mm in particle size), 71.8% by weight of a sand component and 15.6% by weight of a dirt component] was added 10 parts by weight of the diluted Termiticide T (which was 7.5-fold dilution by weight with water), and mixed together with a mixer to give a mixture containing the granite soil and the termiticide dispersed uniformly, then the mixture was dried. Next, the dried mixture and 10 parts by weight of a portland blast-furnace slag cement (Portland blast-furnace slag cement type-B, from Taiheiyo Cement Corporation) were mixed with a mixer to give a hardenable termite-controlling composition (B-1) containing the granite soil, the portland blast-furnace slag cement and the termiticide dispersed uniformly.

Hardenable Termite-Controlling Composition (B-2)

Except that a water-diluted termiticide “Baktop MC” (containing bassa as the active ingredient, manufactured by Sumitomo Chemical Co., Ltd.) which was 8-fold dilution by weight was used instead of the water-diluted Termiticide T (7.5-fold dilution by weight), a hardenable termite-controlling composition (B-2) was prepared in the same manner with the above hardenable termite-controlling composition (B-1).

Hardenable Termite-Controlling Composition (B-3)

Except that a water-diluted termiticide “Grenade MC” (containing fipronil and pralethrin as the active ingredients, manufactured by Sumitomo Chemical Co., Ltd.) which was 15-fold dilution by weight was used instead of the water-diluted Termiticide T (7.5-fold dilution by weight), a hardenable termite-controlling composition (B-3) was prepared in the same manner with the above hardenable termite-controlling composition (B-1).

Hardenable Termite-Controlling Composition (B-4)

Except that a water-diluted termiticide “Rarap MC” (containing cyphenothrin as the active ingredient, manufactured by Sumitomo Chemical Co., Ltd.) which was 10-fold dilution by weight was used instead of the water-diluted Termiticide T (7.5-fold dilution by weight), a hardenable termite-controlling composition (B-4) was prepared in the same process as described above for preparing a hardenable termite-controlling composition (B-1).

Hardenable Termite-Controlling Composition (B-5)

Except that of a water-diluted termiticide “Stealth SC” (containing chlorfenapyr as the active ingredient, manufactured by BASF Agro Ltd.) which was 20-fold dilution by weight was used instead of the water-diluted Termiticide T (7.5-fold dilution by weight), a hardenable termite-controlling composition (B-5) was prepared in the same manner with the above hardenable termite-controlling composition (B-1).

Hardenable Termite-Controlling Composition (B-6)

Except that a water-diluted termiticide “Ariden emulsifiable concentrate-E” (containing ethofenprox as the active ingredient, manufactured by Sankyo Lifetech Co., Ltd.) which was 4-fold dilution by weight was used instead of the water-diluted Termiticide T (7.5-fold dilution by weight), a hardenable termite-controlling composition (B-6) was prepared in the same manner with the above hardenable termite-controlling composition (B-1).

Hardenable Termite-Controlling Composition (B-7)

Except that a water-diluted termiticide “Shinto Natural Pyrethrin MC” (containing pyrethrin as the active ingredient, manufactured by Shinto Fine Co., Ltd.) which was 10-fold dilution by weight was used instead of the water-diluted Termiticide T (7.5-fold dilution by weight), a hardenable termite-controlling composition (B-7) was prepared in the same manner with the above hardenable termite-controlling composition (B-1).

Hardenable termite-controlling composition (B-8) Except that a water-diluted termiticide “Silonen emulsifiable concentrate” (containing silafluofen as the active ingredient, manufactured by Dainihon Jochugiku Co., Ltd.) which was 5-fold dilution by weight was used instead of a water-diluted Termiticide T (7.5-fold dilution by weight), a hardenable termite-controlling composition (B-8) was prepared in the same manner with the above hardenable termite-controlling composition (B-1).

Hardenable Termite-Controlling Composition (B-9)

Except that a water-diluted termiticide “Aripyreth emulsifiable concentrate” (containing bifenthrin as the active ingredient, manufactured by Nihon Noyaku Co., Ltd.) which was 10-fold dilution by weight was used instead of the water-diluted Termiticide T (7.5-fold dilution by weight), a hardenable termite-controlling composition (B-9) was prepared in the same manner with the above hardenable termite-controlling composition (B-1).

Hardenable Termite-Controlling Composition (B-10)

Except that a water-diluted termiticide “Hachikusan FL” (containing imidachloprid as the active ingredient, manufactured by Bayer CropScience) which was 15-fold dilution by weight was used instead of the water-diluted Termiticide T (7.5-fold dilution by weight), a hardenable termite-controlling composition (B-10) was prepared in the same manner with the above hardenable termite-controlling composition (B-1).

Hardenable Termite-Controlling Composition (B-11).

Except that 5% by weight solution of permethrin in methanol was used instead of the water-diluted Termiticide T (7.5-fold dilution by weight), a hardenable termite-controlling composition (B-11) was prepared in the same manner with the above hardenable termite-controlling composition (B-1).

Hardenable Termite-Controlling Composition (C-1)

Except that 20 parts by weight of 5% by weight solution of hinokitiol (manufactured by Osaka Organic Chemical Industry Ltd.) in methanol was used instead of 10 parts by weight of the water-diluted Termiticide T (7.5-fold dilution by weight), a hardenable termite-controlling composition (C-1) was prepared in the same manner with the above hardenable termite-controlling composition (B-1).

Hardenable Termite-Controlling Composition (BS-1)

To 100 parts by weight of a dry granite soil [12.6% by weight of a gravel component (2 to 5 mm in particle size), 71.8% by weight of a sand component and 15.6% by weight of a dirt component] was added 10 parts by weight of a termiticide “Colony Buster” (α-(α,α, α-trifluoro-m-toluoyl)-p-tolunitryl 4-(p-trifluoromethoxyphenyl) semicarbazone as the active ingredient, manufactured by Nihon Noyaku Co., Ltd.), and mixed together with a mixer to give a mixture containing the granite soil and the termiticide dispersed uniformly. Next, the mixture and 10 parts by weight of a portland blast-furnace slag cement (Portland blast-furnace slag cement type-B, manufactured by Taiheiyo Cement Corporation) were mixed with a mixer to give a hardenable termite-controlling composition (BS-1) containing the granite soil, the portland blast-furnace slag cement and the termiticide dispersed uniformly.

Hardenable Termite-Controlling Composition (BC-1)

Except that 5 parts by weight of a boric acid and 5 parts by weight of a borax, both manufactured by Wako Pure Chemical Industries, Ltd., were added instead of the termiticide “Colony Buster”, a hardenable termite-controlling composition (BC-1) was prepared in the same manner with the above hardenable termite-controlling composition (BS-1).

Hardenable Termite-Controlling Composition (BO-1)

To 100 parts by weight of a talc (manufactured by Neorito Kosan Co. Ltd.), was added 10 parts by weight of Termiticide T, and mixed together with a mixer to give a mixture containing the Termiticide T and the talc dispersed uniformly, then the mixture was dried. Next, the dried mixture and 10 parts by weight of a portland blast-furnace slag cement (Portland blast-furnace slag cement type-B, manufactured by Taiheiyo Cement Corporation) were mixed with a mixer to give a hardenable termite-controlling composition (BO-1) containing the termiticide and the portland blast-furnace slag cement dispersed uniformly.

Hardenable Termite-Controlling Composition (B-12)

To 10 parts by weight of the hardenable termite-controlling composition (BO-1) were added 100 parts by weight of a dry granite soil [12.6% by weight of a gravel component (2 to 5 mm in particle size), 71.8% by weight of a sand component and 15.6% by weight of a dirt component] and 10 parts by weight of a portland blast-furnace slag cement (Portland blast-furnace slag cement type-B, manufactured by Taiheiyo Cement Corporation), the resultant was mixed together with a mixer to give a hardenable termite-controlling composition (B-12) containing the Termiticide T, the portland blast-furnace slag cement and the granite soil dispersed uniformly.

Hardenable Termite-Controlling Composition (B-13)

To 100 parts by weight of a pumice “Kagalite 4M” (manufactured by Kagalite Kogyo Co., Ltd.) was added 10 parts by weight of Termiticide T, and the resultant was mixed together with a mixer to give a mixture containing the termiticide and the pumice dispersed uniformly, then the mixture was dried. Next, 10 parts by weight of the dried mixture, 100 parts by weight of the dried granite soil [12.6% by weight of a gravel component (2 to 5 mm in particle size), 71.8% by weight of a sand component and 15.6% by weight of a dirt component] and 10 parts by weight of a portland blast-furnace slag cement (Portland blast-furnace slag cement type-B, manufactured by Taiheiyo Cement Corporation) were mixed together with a mixer to give a hardenable termite-controlling composition (B-13) containing the Termiticide T, the portland blast-furnace slag cement and the granite soil dispersed uniformly.

Hardenable Termite-Controlling Composition (BD-1)

To 90 parts by weight of the hardenable termite-controlling composition (B-13) was added 10 parts by weight of a catalytic composition having an antifungal and deodorant effect “Seventol NP-C” (manufactured by Japan EnviroChemicals, Ltd.), the resultant was mixed together with a mixer to give a hardenable termite-controlling composition (BD-1) having a termiticidal activity as well as an antifungal and deodorant effect, which contained the Termiticide T, the portland blast-furnace slag cement, and the catalytic composition dispersed uniformly.

Hardenable Termite-Controlling Composition (BD-2)

To 80 parts by weight of the hardenable termite-controlling composition (B-13) was added 20 parts by weight of an activated carbon with a humidity-conditioning and deodorant effect “Shirasagi M” (manufactured by Japan EnviroChemicals, Ltd.), the resultant was mixed together with a mixer to give a hardenable termite-controlling composition (BD-2) having an termiticidal activity as well as a humidity-conditioning and deodorant effect, containing the Termiticide T, the portland blast-furnace slag cement, the granite soil and the activated carbon each of which are dispersed uniformly.

Hardenable Termite-Controlling Composition (BH-1)

To 100 parts by weight of a sepiolite powder having a humidity-conditioning effect (manufactured by Mizusawa Industrial Chemicals, Ltd.) was added 3 parts by weight of Termiticide T, the resultant was mixed together with a mixer to prepare a mixture containing the termiticide and the sepiolite each of which is dispersed uniformly, then the mixture was dried. Next, 50 parts by weight of the dried mixture, 40 parts by weight of a dry granite soil [12.6% by weight of a gravel component (2 to 5 mm in particle size), 71.8% by weight of a sand component and 15.6% by weight of a dirt component] and 10 parts by weight of the portland blast-furnace slag cement (Portland blast-furnace slag cement type-B, manufactured by Taiheiyo Cement Corporation) were mixed with a mixer to give a hardenable termite-controlling composition (BH-1) with both an anti-termite activity and a humidity-conditioning property, having the Termiticide T, the sepiolite, the portland blast-furnace slag cement and the granite soil dispersed uniformly.

Hardenable Termite-Controlling Composition (A-2)

Soil components containing 70% by weight of a gravel component (2 to 5 mm in particle size), 15% by weight of a sand component and 15% by weight of a dirt component were uniformly mixed with a mixer to give a soil containing the gravel component, the sand component and the dirt component dispersed uniformly. Next, 100 parts by weight of the soil and 10 parts by weight of a portland blast-furnace slag cement (Portland blast-furnace slag cement type-B, manufactured by Taiheiyo Cement Corporation) were mixed with a mixer to give a hardenable termite-controlling composition (A-2) having the soil and the portland blast-furnace slag cement dispersed uniformly.

Hardenable Termite-Controlling Composition (B-14)

To 100 parts by weight of a pumice “Kagalite 4M” (manufactured by Kagalite Kogyo Co, Ltd.) was added 10 parts by weight of a tridecanol having a termite-controlling activity (manufactured by Kyowa Hakko Kogyo Co., Ltd.), the resultant was mixed together with a mixer to give a mixture containing the termiticide and the pumice dispersed uniformly, then the mixture was dried. Next, 10 parts by weight of the dried mixture, 100 parts by weight of a dry granite soil [12.6% by weight of a gravel component (2 to mm in particle size), 71.8% by weight of a sand component and 15.6% by weight of a dirt component] and 15 parts by weight of a portland blast-furnace slag cement (Portland blast-furnace slag cement type-B, manufactured by Taiheiyo Cement Corporation) were mixed together with a mixer to give a hardenable termite-controlling composition (B-14) containing tridecanol, the portland blast-furnace slag cement and the granite soil dispersed uniformly.

Hardenable Termite-Controlling Composition (D-1)

To 100 parts by weight of a pumice “Kagalite 4M” (manufactured by Kagalite Kogyo Co., Ltd.) was added 10 parts by weight of Termiticide T, the resultant was mixed together with a mixer to give a mixture containing the termiticide and the pumice dispersed uniformly, then the mixture was dried. Next, 10 parts by weight of the dried mixture, 100 parts by weight of a crushed brick (the particle size distribution=2 to 3 mm: 40% by weight, 0.2 mm to less than 2 mm (0.2 to 2 mm excluding 2 mm): 30% by weight, and less than 0.2 mm: 30% by weight; hereinafter the same distribution is adopted) and 15 parts by weight of the portland blast-furnace slag cement (Portland blast-furnace slag cement type-B, manufactured by Taiheiyo Cement Corporation) were mixed together with a mixer to give a hardenable termite-controlling composition (D-1) containing the crushed brick, the portland blast-furnace slag cement and the termiticide dispersed uniformly.

Hardenable Termite-Controlling Composition (D-2)

Except that a crushed unglazed plant pot (the particle size distribution=2 to 3 mm: 20% by weight, 0.2 mm to less than 2 mm (0.2 to 2 mm excluding 2 mm): 60% by weight, and less than 0.2 mm: 20% by weight; hereinafter the same distribution is adopted) was used instead of the crushed brick, a hardenable termite-controlling composition (D-2) was prepared in the same manner with the above hardenable termite-controlling composition (D-1).

Hardenable Termite-Controlling Composition (D-3)

Except that a crushed roof tile (the particle size distribution=2 to 3 mm: 60% by weight, 0.2 mm to less than 2 mm (0.2 to 2 mm excluding 2 mm): 25% by weight, and less than 0.2 mm: 15% by weight; hereinafter the same distribution is adopted) was used instead of the crushed brick, a hardenable termite-controlling composition (D-3) was prepared in the same manner with the above hardenable termite-controlling composition (D-1).

Hardenable Termite-Controlling Composition (D-4)

Except that a crushed concrete block (the particle size distribution=2 to 3 mm: 45% by weight, 0.2 mm to less than 2 mm (0.2 to 2 mm excluding 2 mm): 45% by weight, and less than 0.2 mm: 10% by weight; hereinafter the same distribution is adopted) was used instead of the crushed brick, a hardenable termite-controlling composition (D-4) was prepared in the same manner with the above hardenable termite-controlling composition (D-1).

Hardenable Termite-Controlling Composition (D-5)

Except that a crushed glass (the particle size distribution=2 to 3 mm: 40% by weight, 0.2 mm to less than 2 mm (0.2 to 2 mm excluding 2 mm): 55% by weight, and less than 0.2 mm: 5% by weight; hereinafter the same distribution is adopted) was used instead of the crushed brick, and that 25 parts by weight of the portland blast-furnace slag cement was used, a hardenable termite-controlling composition (D-5) was prepared in the same manner with the above hardenable termite-controlling composition (D-1).

Hardenable Termite-Controlling Composition (D-6)

Except that a crushed ceramic (a bowl or cup) (the particle size distribution=2 to 3 mm: 45% by weight, 0.2 mm to less than 2 mm (0.2 to 2 mm excluding 2 mm): 50% by weight, and less than 0.2 mm: 5% by weight; hereinafter the same distribution is adopted) was used instead of the crushed glass, a hardenable termite-controlling composition (D-6) was prepared in the same manner with the above hardenable termite-controlling composition (D-5).

Hardenable Termite-Controlling Composition (D-7)

Except that a crushed shell of a short-neck clam (the particle size distribution=2 to 5 mm: 50% by weight, 0.2 mm to less than 2 mm (0.2 to 2 mm excluding 2 mm): 45% by weight, and less than 0.2 mm: 5% by weight; hereinafter the same distribution is adopted) was used instead of the crushed glass, a hardenable termite-controlling composition (D-7) was prepared in the same manner with the above hardenable termite-controlling composition (D-5).

Hardenable Termite-Controlling Composition (E-1)

Except that 50 parts by weight of the crushed brick and 50 parts by weight of a dry granite soil [12.6% by weight of a gravel component (2 to 5 mm in particle size), 71.8% by weight of a sand component and 15.6% by weight of a dirt component] were used instead of 100 parts by weight of the crushed brick, a hardenable termite-controlling composition (E-1) was prepared in the same manner with the above hardenable termite-controlling composition (D-1).

Hardenable Termite-Controlling Composition (E-2)

Except that the crushed unglazed plant pot was used instead of the crushed brick, a hardenable termite-controlling composition (E-2) was prepared in the same manner with the above hardenable termite-controlling composition (E-1).

Hardenable Termite-Controlling Composition (E-3)

Except that the crushed roof tile was used instead of the crushed brick, a hardenable termite-controlling composition (E-3) was prepared in the same manner with the above hardenable termite-controlling composition (E-1).

Hardenable Termite-Controlling Composition (E-4)

Except that the crushed concrete block was used instead of the crushed brick, a hardenable termite-controlling composition (E-4) was prepared in the same manner with the above hardenable termite-controlling composition (E-1).

Hardenable Termite-Controlling Composition (E-5)

Except that the crushed glass was used instead of the crushed brick, a hardenable termite-controlling composition (E-5) was prepared in the same manner with the above hardenable termite-controlling composition (E-1).

Hardenable Termite-Controlling Composition (E-6)

Except that the crushed ceramic (a bowl or cup) was used instead of the crushed brick, a hardenable termite-controlling composition (E-6) was prepared in the same manner with the above hardenable termite-controlling composition (E-1).

Hardenable Termite-Controlling Composition (E-7)

Except for the crushed shell of the short-neck clam was used instead of the crushed brick, a hardenable termite-controlling composition (E-7) was prepared in the same manner with the above hardenable termite-controlling composition (E-1).

### Example 1

To a quartz sand (or a silica sand) passed through a 120 mesh sieve, was applied water to obtain a water-containing quartz sand having a water content of 10% by weight. The water-containing quartz sand was laid (or spread) in a thickness of 3 cm in a plastic cylinder having an inner diameter of about 3.5 cm, with the bottom covered with a plastic cover. Then the hardenable termite-controlling composition (A-1) was spread in a thickness of 3 cm on the laid water-containing quartz sand. After the spreading, about 1.5 L/m of water was sprinkled over the composition (A-1) (the first water sprinkling). After standing for 1 hour from the first water sprinkling, about 5 L/m² of an additional water was sprinkled over the composition (A-1) (the second water sprinkling). The solidification (or hardening) of the composition (A-1) was confirmed after 24 hours. Seven days after the solidification, the bottom cover of the cylinder was removed, and the cylinder without the bottom cover was placed on the center of a Petri dish (9 cm in diameter) in which the water-containing quartz sand was spread in a thickness of 1 cm. On the solidified composition (A-1), a pine wood (cut end: 1 cm×1 cm, length: 2 cm) was set as a food. Thereafter, formosan subterranean termites (Coptotermes formosanus) consisting of 150 workers and 15 soldiers were released on the water-containing quartz sand in the Petri dish, and the damage state of the wood and the mortality of termites were investigated. As a result, termite damage to the wood was not observed even 3 weeks after releasing the termites.

### Comparative Example 1

The water-containing quartz sand prepared in the same manner with EXAMPLE 1 (water content: 10% by weight) was laid in a thickness of 3 cm in a plastic cylinder having an inner diameter of about 3.5 cm, with the bottom covered with a plastic cover. Then the bottom cover of the cylinder was removed, and the cylinder without the bottom cover was placed on the center of a Petri dish (9 cm in diameter) in which the water-containing quartz sand was spread in a thickness of 1 cm. On the water-containing quartz sand in the cylinder, a pine wood (cut end: 1 cm×1 cm, length: 2 cm) was set as a food. Thereafter, formosan subterranean termites (Coptotermes formosanus) consisting of 150 workers and 15 soldiers were released on the water-containing quartz sand in the Petri dish, and the damage state of the wood and the mortality of termites were investigated. As a result, one day after releasing the termites, traces of the termite damage to the pine wood were observed.

### Example 2

Except that the water-diluted solution of Termiticide T (which was 50-fold dilution by weight) was sprinkled instead of the water in the first sprinkling, the same experiment as EXAMPLE 1 was conducted. As a result, all the termites were dead until 7 days after releasing the termites. Moreover, no termite damage to the wood was observed.

### Example 3

Except that the water-diluted solution of Termiticide T (which was 500-fold dilution by weight) was sprinkled instead of the water in the second sprinkling, the same experiment as EXAMPLE 1 was conducted. As a result, all the termites were dead until 7 days after releasing the termites. Moreover, no termite damage to the wood was observed.

### Example 4

Except that the 100-fold and 1000-fold water dilutions of Termiticide T were sprinkled instead of the waters in the first and second sprinklings, respectively, the same experiment as EXAMPLE 1 was conducted. As a result, all the termites were dead until 7 days after releasing the termites. Moreover, no termite damage to the wood was observed.

### Example 5

Except that another 3 ml of the water dilution of Termiticide T (which was 100-fold dilution by weight) was sprinkled at 24 hours after sprinkling the second water, the same experiment as EXAMPLE 1 was conducted. As a result, all the termites were dead until 7 days after releasing the termites. Moreover, no termite damage to the wood was observed.

### Example 6

Except that the hardenable termite-controlling composition (B-1) was used instead of the hardenable termite-controlling composition (A-1), the same experiment as EXAMPLE 1 was conducted. As a result, all the termites were dead until 7 days after releasing the termites. Moreover, no termite damage to the wood was observed.

### Example 7

The water-containing quartz sand prepared in the same manner with EXAMPLE 1 (water content: 10% by weight) was laid in a thickness of 3 cm in a plastic cylinder having an inner diameter of about 3.5 cm, with the bottom covered with a plastic cover, and the hardenable termite-controlling composition (B-1) was laid on the sand in a thickness of 1 cm. To 100 g of Toyo Instant Cement (manufactured by Toyo Matelan Corporation), was added 22.5 mL of water, and the resultant was kneaded together. Then, the kneaded mixture was laid on the laid termite-controlling composition in a thickness of 3 cm. Seven days after laying of the composition (B-1), the bottom cover of the cylinder was removed, and the cylinder without the bottom cover was set at the center of a Petri dish (9 cm in diameter) in which the water-containing quartz sand was spread in a thickness of 1 cm. On the solidified instant cement, a pine wood (cut end: 1 cm×1 cm, length: 2 cm) was set as a food. Thereafter, formosan subterranean termites (Coptotermes formosanus) consisting of 150 workers and 15 soldiers were released on the water-containing quartz sand in the Petri dish, and the damage state of the wood and the mortality of termites were investigated. As a result, all the termites were dead until 7 days after releasing the termites. Moreover, no termite damage to the wood was observed. Incidentally, the composition (B-1) had been fully solidified in the cylinder.

### Example 8

The water-containing quartz sand prepared in the same manner with EXAMPLE 1 (water content: 10% by weight) was laid in a thickness of 3 cm in a plastic cylinder having an inner diameter of about 3.5 cm, with the bottom covered with a plastic cover, and the hardenable termite-controlling composition (B-1) was laid on the sand in a thickness of 1 cm. Three days after laying the composition (B-1), the solidification of the surface of the composition (B-1) was confirmed, and the bottom cover of the cylinder was removed, then the cylinder without the bottom cover was set at the center of a Petri dish (9 cm in diameter) containing the water-containing quartz sand in which the water-containing quartz sand was spread in a thickness of 1 cm. On the surface-solidified composition (B-1), a pine wood (cut end: 1 cm×1 cm, length: 2 cm) was set as a food. Thereafter, formosan subterranean termites (Coptotermes formosanus) consisting of 150 workers and 15 soldiers were released on the water-containing quartz sand in the Petri dish, and the damage state of the wood and the mortality of termites were investigated. As a result, all the termites were dead until 7 days after releasing the termites. Moreover, no termite damage to the wood was observed.

### Example 9

The water-containing quartz sand prepared in the same manner with EXAMPLE 1 (water content: 10% by weight) was laid in a thickness of 3 cm in a plastic cylinder having an inner diameter of about 3.5 cm, with the bottom covered with a plastic cover. To 30 g of the hardenable termite-controlling composition (A-1) was added 3 g of water, and the resultant was uniformly mixed, then a part of the mixture was laid on the water-containing quartz sand in a thickness of 3 cm. One day (24 hours) after laying of the composition (A-1), the solidification of the composition (A-1) was confirmed. At 7 days after the solidification, the bottom cover of the cylinder was removed, and the cylinder without the bottom cover was set at the center of a Petri dish (9 cm in diameter) in which the water-containing quartz sand was spread in a thickness of 1 cm. On the surface-solidified composition (A-1), a pine wood (cut end: 1 cm×1 cm, length: 2 cm) was set as a food. Thereafter, formosan subterranean termites (Coptotermes formosanus) consisting of 150 workers and 15 soldiers were released on the water-containing quartz sand in the Petri dish, and the damage state of the wood and the mortality of termites were investigated. As a result, no termite damage to the wood was observed even 3 weeks after releasing the termite.

### Example 10

Except that 3 g of the water-diluted solution of Termiticide T (which was 15-fold dilution by weight) was mixed instead of the water, the same experiment as EXAMPLE 9 was conducted. As a result, all the termites were dead until 7 days after releasing the termites. Moreover, no termite damage to the wood was observed.

### Examples 11 to 20

In EXAMPLES 11 to 20, Reticulitermes speratus were employed instead of formosan subterranean termites (Coptotermes formosanus) used in EXAMPLES 1 to 10. In each EXAMPLE (11 to 20) corresponding to EXAMPLES 1 to 10, the result for Reticulitermes speratus was also similar to the result for formosan subterranean termites (Coptotermes formosanus).

### Examples 21 to 30

Except that the hardenable termite-controlling compositions shown in Table 1 were used instead of the hardenable termite-controlling composition (A-1), the same experiment as EXAMPLE 1 was conducted. The results are shown in Table 1. Incidentally, in Table 1, the symbols with respect to the state of the termite damage to the wood represent the following meanings:

“A”: no termite damage was observed,

“B”: the termite damage was slightly observed,

“C”: the termite damage was observed.

TABLE 1
Table 1

| | | | | | | | EX | | | | EX |
|---|---|---|---|---|---|---|---|---|---|---|---|
| | | EX 21 | EX 22 | EX 23 | EX 24 | EX 25 | 26 | EX 27 | EX 28 | EX 29 | 30 |
| Hardenable | | B-2 | B-3 | B-4 | B-5 | B-6 | B-7 | B-8 | B-9 | B-10 | B-11 |
| termite-controlling | | | | | | | | | | | |
| composition | | | | | | | | | | | |
| Soil | Gravel | 12.6 | 12.6 | 12.6 | 12.6 | 12.6 | 12.6 | 12.6 | 12.6 | 12.6 | 12.6 |
| component | Sand | 71.8 | 71.8 | 71.8 | 71.8 | 71.8 | 71.8 | 71.8 | 71.8 | 71.8 | 71.8 |
| (% by | Dirt | 15.6 | 15.6 | 15.6 | 15.6 | 15.6 | 15.6 | 15.6 | 15.6 | 15.6 | 15.6 |
| weight) | | | | | | | | | | | |

| | | | | | | | | | | |
|---|---|---|---|---|---|---|---|---|---|---|
| Termiticide | Bassa | Fipronil | Cyphenothrin | Chlorphenapyr | Ethofenprox | Pyre- | Silafluofen | Bifenthrin | Imidachloprid | Per- |
| (active ingredient) | | Pralethrin | | | | thrin | | | | meth- |
| | | | | | | | | | | rin |
| Antifungal component | — | — | — | — | — | — | — | — | — | — |
| Deodorant component | — | — | — | — | — | — | — | — | — | — |
| Humidity-conditioning | — | — | — | — | — | — | — | — | — | — |
| component | | | | | | | | | | |

Coptotermes formosanus

| | | | | | | | | | | |
|---|---|---|---|---|---|---|---|---|---|---|
| Termite damage | A | A | A | A | A | A | A | A | A | A |
| to the wood | | | | | | | | | | |
| Living termites (%) | 0 | 0 | 50 | 0 | 90 | 90 | 90 | 60 | 0 | 70 |
| 7 days after releasing | | | | | | | | | | |

Reticulitermes speratus

| | | | | | | | | | | |
|---|---|---|---|---|---|---|---|---|---|---|
| Termite damage | A | A | A | A | A | A | A | A | A | A |
| to the wood | | | | | | | | | | |
| Living termites (%) | 0 | 0 | 30 | 0 | 80 | 90 | 90 | 60 | 0 | 70 |
| 7 day after releasing | | | | | | | | | | |

### Examples 31 to 40

Except that the hardenable termite-controlling compositions shown in Table 1 were used instead of the hardenable termite-controlling composition (A-1), the same experiment as EXAMPLE 1 was conducted. The results are shown in Table 2. Incidentally, in Table 2, the symbols showing the state of the termite damage to the wood have the same meanings as in above Table 1.

TABLE 2
Table 2

| | | | | EX | | | | | | EX | |
|---|---|---|---|---|---|---|---|---|---|---|---|
| | | EX 31 | EX 32 | 33 | EX 34 | EX 35 | EX 36 | EX 37 | EX 38 | 39 | EX 40 |
| Hardenable | | C-1 | BS-1 | BC-1 | B-12 | B-13 | BD-1 | BD-2 | BH-1 | A-2 | B-14 |
| termite-controlling | | | | | | | | | | | |
| composition | | | | | | | | | | | |
| Soil | Gravel | 12.6 | 12.6 | 12.6 | 12.6 | 12.6 | 12.6 | 12.6 | 12.6 | 70 | 12.6 |
| component | Sand | 71.8 | 71.8 | 71.8 | 71.8 | 71.8 | 71.8 | 71.8 | 71.8 | 15 | 71.8 |
| (% by | Dirt | 15.6 | 15.6 | 15.6 | 15.6 | 15.6 | 15.6 | 15.6 | 15.6 | 15 | 15.6 |
| weight) | | | | | | | | | | | |

| | | | | | | | | | | |
|---|---|---|---|---|---|---|---|---|---|---|
| Termiticide | — | (α-(α,α, | Boric | Chlotianidin | Chlotianidin | Chlotianidin | Chlotianidin | chlotianidin | — | Tridecanol |
| (active ingredient) | | α-Triluoro- | acid | | | | | | | |
| | | m- | | | | | | | | |
| | | toluo- | | | | | | | | |
| | | yl)-p- | | | | | | | | |
| | | tolunitrile | | | | | | | | |
| | | 4-(p-tri- | | | | | | | | |
| | | fluoromethoxy- | | | | | | | | |
| | | phenyl)- | | | | | | | | |
| | | semicar- | | | | | | | | |
| | | bazone | | | | | | | | |
| Antifungal component | Hinokitiol | — | Bo- | — | — | — | — | — | — | — |
| | | | rax | | | | | | | |
| Deodorant component | — | — | — | — | — | Catalytic | Activated | — | — | — |
| | | | | | | composition | carbon | | | |
| Humidity-conditioning | — | — | — | — | — | — | — | Sepiolite | — | — |
| component | | | | | | | | | | |

Coptotermes formosanus

| | | | | | | | | | | |
|---|---|---|---|---|---|---|---|---|---|---|
| Termite damage | A | A | A | A | A | A | A | A | A | A |
| to the wood | | | | | | | | | | |
| Living termites (%) | 100 | 40 | 80 | 0 | 0 | 0 | 0 | 0 | 100 | 100 |
| 7 days after releasing | | | | | | | | | | |

Reticulitermes speratus

| | | | | | | | | | | |
|---|---|---|---|---|---|---|---|---|---|---|
| Termite damage | A | A | A | A | A | A | A | A | A | A |
| to the wood | | | | | | | | | | |
| Living termites (%) | 100 | 40 | 80 | 0 | 0 | 0 | 0 | 0 | 100 | 100 |
| 7 day after releasing | | | | | | | | | | |

### Example 41

A dry quartz sand was used instead of the water-containing quartz sand in EXAMPLE 1, and a dry granite soil was used instead of the hardenable termite-controlling composition (A-1) in EXAMPLE 1. Then, 5 L/m of the hardenable termite-controlling composition (BO-1) was spread over these matters. Except above, the same experiment as EXAMPLE 1 was conducted to give a solidified termite-controlling layer after 1 week after spreading. Thereafter, the damage state of the wood and the mortality of termites were investigated as in EXAMPLE 1. As a result, no termite damage to the wood was observed even 3 weeks after releasing the termites.

### Example 42

The hardenable termite-controlling composition (B-1) was spread uniformly all over the underfloor ground of a Japanese-style room of a private house in Osaka Prefecture in a thickness of 3 cm. Thereafter, water was sprinkled in the proportion of 3 L/m to solidify the composition (B-1) to form a termite-controlling layer. At one month after spreading the composition, the humidity was 95% in the underfloor area not subjected to the above execution, while the humidity was 85% in the underfloor area where the termite-controlling layer was formed. Thus, it was found that an excellent humidity-conditioning effect was exerted by the formation of the termite-controlling layer.

### Example 43

To 100 parts by weight of each of the hardenable termite-controlling compositions, (D-1) to (D-7) and (E-1) to (E-7), was added 15 parts by weight of water. In each composition, the resultant was mixed together to give a mixture, then the mixture was spread uniformly over the edge of a mat foundation on the underfloor ground in a thickness of 2 cm and in a width of 5 cm. One week after spreading, a solidified termite-controlling layer was obtained. Thereafter, the damage state of the wood and the mortality of termites were investigated as in EXAMPLE 1. As a result, no termite damage to the wood was observed even 3 weeks after releasing the termites.

1. A hardenable termite-controlling composition which comprises a hydraulic material and at least one member selected from the group consisting of a soil and a termiticide, and is in the form of a dust-granule mixture.

2-3. (canceled)

4. A hardenable termite-controlling composition according to claim 1, which is prepared without mixing a water.

5. A hardenable termite-controlling composition according to claim 1, wherein the soil comprises a gravel component and a fine grain component, and the weight ratio of the gravel component relative to the fine grain component is 99.9/0.1 to 5/95.

6. A hardenable termite-controlling composition according to claim 5, wherein the fine grain component comprises a sand component and a dirt component, and the weight ratio of the sand component relative to the dirt component is 99/1 to 10/90.

7. A hardenable termite-controlling composition according to claim 1, wherein the soil comprises a crushed inorganic waste.

8. A hardenable termite-controlling composition according to claim 1, wherein the weight ratio of the soil relative to the hydraulic material is 95/5 to 70/30.

9. A process for controlling a termite, which comprises at least a step (A) for laying a hardenable termite-controlling composition recited in claim 1 on an area to be treated.

10. A termite-controlling process according to claim 9, comprising the step (A) for laying the hardenable termite-controlling composition on the area to be treated, and a step (B) for applying at least a water to the laid hardenable termite-controlling composition.

11. A termite-controlling process according to claim 10, wherein the step (B) comprises a step (B₁) for applying a liquid containing at least a water to the laid hardenable termite-controlling composition, or a step (B₂) for laying a concrete or soil containing at least a water on the laid hardenable termite-controlling composition.

12. A termite-controlling process according to claim 11, wherein the liquid applied in the step (B₁) contains a termiticide.

13. A process for controlling a termite, which comprises a step (C) for mixing a hardenable termite-controlling composition recited in claim 1 with at least a water, and a step (D) for laying the mixture on an area to be treated.

14. A termite-controlling process according to claim 13, wherein the hardenable termite-controlling composition, the water and a termiticide are mixed in the step (C).

15. A termite-controlling process according to claim 9, wherein the area to be treated includes at least one area selected from the group consisting of an infested area, an inhabited area and a breeding area of termites.

16. A termite-controlling process according to claim 13, wherein the area to be treated includes at least one area selected from the group consisting of an infested area, an inhabited area and a breeding area of termites.
